(19) United States
(12) Patent Application Publication
(10) Pub. No.: US 2017/0324997 A1
(43) Pub. Date: Nov. 9, 2017

(54) VIDEO DISPLAY SYSTEM, INFORMATION PROCESSING DEVICE, PORTABLE TERMINAL DEVICE, AND PROGRAM

(71) Applicant: Sharp Kabushiki Kaisha, Sakai City, Osaka (JP)

(72) Inventors: Tsuneaki UMEMOTO, Sakai City (JP); Norikazu HOHSHI, Sakai City (JP); Tatsuya KATOH, Sakai City (JP)

(21) Appl. No.: 15/527,745

(22) PCT Filed: Nov. 16, 2015
(86) PCT No.: PCT/JP2015/082058

§ 371 Date: May 18, 2017

(30) Foreign Application Priority Data
Nov. 21, 2014 (JP) 2014-236506

(51) Int. Cl. H04N 21/472; H04N 21/222; H04N 21/2665; H04N 21/436

(52) U.S. Cl. CPC H04N 21/47202; H04N 21/436; H04N 21/222; H04N 21/2665

(57) ABSTRACT

A video display system is a video display system which includes an information processing device and a portable terminal device. The information processing device includes: a reception unit configured to receive video contents; a conversion unit configured to convert video contents received by the reception unit into video data to be transmitted to the portable terminal device; a transmission unit configured to transmit video data obtained through a conversion by the conversion unit to the portable terminal device using a wireless communication via a public network. The portable terminal device includes: an acquisition unit configured to acquire video data transmitted from the information processing device using a wireless communication via a public network; and a terminal transmission unit configured to transmit video data acquired by the acquisition unit to a display device using a wireless communication.

### TECHNICAL FIELD

Some aspects of the present invention relate to a video display system, an information processing device, a portable terminal device, and a program.

Priority is claimed on Japanese Patent Application No. 2014-236506, filed Nov. 21, 2014, the content of which is incorporated herein by reference.

### BACKGROUND ART

With the spread of high-speed communication of the Internet in addition to broadcast content of terrestrial digital broadcasting, satellite broadcasting, and a cable television (CATV), services for providing video content based on data of video on demand (VOD) or the like are spreading. An amount of such content is increasing and a receiver for each service (so-called set-top box) is necessary when services of various types of content are received. Also, a wired connection such as an antenna wire, a dedicated cable, or a local area network (LAN) cable or a wired connection to a TV device for receiving content with a set-top box is necessary and complicated.

In Patent Document 1, a set-top box that connects to the Internet via a portable phone communication network by wirelessly connecting to the portable phone communication network and displays information of a homepage on a TV is disclosed. According to this, there is no need for a connection cable for a wired connection to the Internet and it is possible to establish a connection to the Internet even in an environment in which wired connection to the Internet is difficult. Also, this set-top box is equipped with a TV tuner and can cause a TV device to simultaneously display the broadcast content of the TV and the homepage.

### PRIOR ART DOCUMENT

### Patent Document

### Patent Document 1

Japanese Patent Application Publication No. 2006-270624

### SUMMARY OF THE INVENTION

Problem to Be Solved by the Invention

However, in Patent Document 1, the connection to the Internet can be wirelessly established via the portable phone communication network, but there is inconvenience in that complication is not eliminated because a dedicated set-top box is necessary and wiring is also necessary for viewing the TV.

Some aspects of the present invention provide a video display system, an information processing device, a portable terminal device, and a program for improving convenience when video content based on TV broadcasting or Internet distribution is viewed.

### Means for Solving the Problems

One aspect of the present invention is a video display system including an information processing device and a portable terminal device, wherein the information processing device includes: a reception unit configured to receive video contents; a conversion unit configured to convert video contents received by the reception unit into video data to be transmitted to the portable terminal device; and a transmission unit configured to transmit video data obtained through a conversion by the conversion unit to the portable terminal device using a wireless communication via a public network, and wherein the portable terminal device includes: an acquisition unit configured to acquire video data transmitted from the information processing device using a wireless communication via a public network; and a terminal transmission unit configured to transmit video data acquired by the acquisition unit to a display device using a wireless communication.

In addition, one aspect of the present invention is that, in the above-described video display system a video display system, video contents received by the reception unit includes broadcast contents transmitted by a broadcast wave of a television.

In addition, one aspect of the present invention is that, in the above-described video display system, video contents received by the reception unit includes cable television broadcast contents transmitted via a cable.

In addition, one aspect of the present invention is that, in the above-described video display system, video contents received by the reception unit includes video contents distributed on a video on demand.

In addition, one aspect of the present invention is that, in the above-described video display system, the reception unit receives video contents according to a request information transmitted from the portable terminal device using a wireless communication via a public network, and the portable terminal device includes: a request unit configured to transmit a request information for requesting a video content to be transmitted to a display device to the information processing device using a wireless communication via a public network.

In addition, one aspect of the present invention is that, in the above-described video display system, the reception unit is able to receive video contents transmitted in a plurality of broadcasting schemes, and the reception unit receives a video content according to a request information to be transmitted from the portable terminal device among video contents transmitted in a plurality of broadcasting schemes.

In addition, one aspect of the present invention is that, in the above-described video display system, a request information transmitted by the request unit includes an information indicating a selected broadcasting scheme, a video content provider, or a program.

In addition, one aspect of the present invention is that, in the above-described video display system, the information processing device includes one or more servers connected to a public network and is configured as a server that provides the portable terminal device with video contents received according to a request information transmitted from the portable terminal device.

In addition, one aspect of the present invention is an information processing device including: a conversion unit configured to convert video contents received by a reception unit into video data to be transmitted to a portable terminal device; and a transmission unit configured to transmit video data obtained through a conversion by the conversion unit to the portable terminal device using a wireless communication via a public network.

In addition, one aspect of the present invention is a portable terminal device including: an acquisition unit configured to acquire video data into which an information processing device converts video content received by a reception unit from the information processing device using a wireless communication via a public network; and a terminal transmission unit configured to transmit video data acquired by the acquisition unit to a display device using a wireless communication.

In addition, one aspect of the present invention is that, the above-described includes: a request unit configured to transmit a request information for requesting a video content for transmission to a display device to the information processing device using a wireless communication via a public network; and a selection unit configured to select an information for specifying video content requested from the request unit according to an operation input of a user.

In addition, one aspect of the present invention is a program for causing a computer to execute the steps of: acquiring video data into which an information processing device converts video contents received by a reception unit from the information processing device using a wireless communication via a public network; and transmitting an acquired video data to a display device using a wireless communication.

### Effect of the Invention

According to some aspects of the present invention, it is possible to improve convenience when video content based on TV broadcasting or Internet distribution is viewed.

### BRIEF DESCRIPTIONS OF THE DRAWINGS

FIG. 1 is a schematic diagram illustrating an example of a video display system according to a first embodiment.

FIG. 2 is a block diagram illustrating an example of a schematic configuration of a virtual set-top box according to the first embodiment.

FIG. 3 is a block diagram illustrating an example of a schematic configuration of a portable information terminal according to the first embodiment.

FIG. 4 is an operation diagram illustrating an example of an operation of a video display process according to the first embodiment.

FIG. 5 is a schematic diagram illustrating an example of a video display system according to a second embodiment.

FIG. 6 is a block diagram illustrating an example of a schematic configuration of a virtual set-top box according to the second embodiment.

FIG. 7 is a schematic diagram illustrating an example of a video display system according to a third embodiment.

FIG. 8 is a block diagram illustrating an example of a schematic configuration of a virtual set-top box according to the third embodiment.

FIG. 9 is a schematic diagram illustrating an example of a video display system according to a fourth embodiment.

FIG. 10 is a block diagram illustrating an example of a schematic configuration of a virtual set-top box according to the fourth embodiment.

FIG. 11 is an explanatory diagram of a TV device according to a fifth embodiment.

### EMBODIMENTS FOR CARRYING OUT THE INVENTION

Embodiments of the present invention will be described below with reference to the drawings.

### First Embodiment

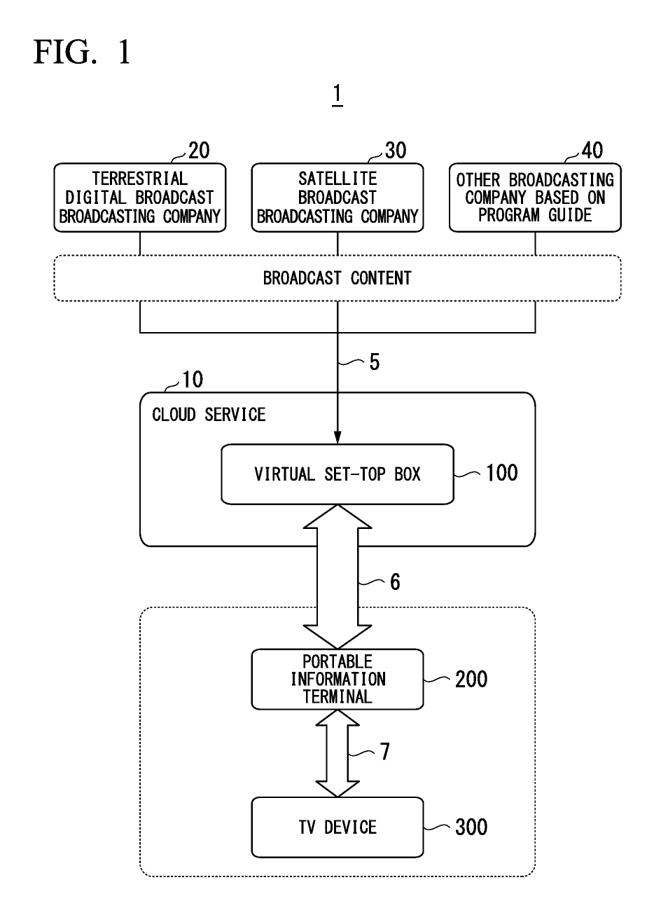

FIG. 1 is a schematic diagram illustrating an example of a video display system 1 according to the first embodiment.

As illustrated in FIG. 1, in the present embodiment, the function of the set-top box is provided as that of a virtual set-top box 100 (an example of an information processing device) on a cloud and the function of the set-top box is configured to be provided by the cloud service 10. For example, the virtual set-top box 100 includes one or more servers connected to a public network and is configured as a server that provides video content received according to request information transmitted from the portable information terminal 200 (an example of a portable terminal device) to the portable information terminal 200.

Here, the video content received by the virtual set-top box 100 is, for example, broadcast content provided by broadcast waves 5 from TV broadcasting companies (broadcasting stations). For example, the virtual set-top box 100 receives broadcast content from a terrestrial digital broadcast broadcasting company 20, a satellite broadcast broadcasting company 30, or another broadcasting company 40 based on a program guide.

The portable information terminal 200 is, for example, a general-purpose portable terminal device such as a smartphone or a tablet type computer and is connected to the virtual set-top box 100 on the cloud using the wireless communication 6 via the public network. Also, the portable information terminal 200 is connected to a TV device 300 (an example of a display device) by proximity communication 7. Thereby, the broadcast content received by the virtual set-top box 100 can be viewed by the TV device 300 via the portable information terminal 200.

Here, the public network is, for example, a portable phone communication network (for example, a communication network based on the third generation mobile communication (3G) or a communication network based on the fourth generation mobile communication (4G)), a PHS communication network, a public wireless LAN, or the like. Here, the portable information terminal 200 will be described as being connected to the virtual set-top box 100 via a portable phone communication network. The proximity communication 7 is short-range wireless communication, and is, for example, wireless communication using a wireless LAN, Bluetooth (registered trademark), or the like.

### (Configuration of Virtual Set-Top Box 100)

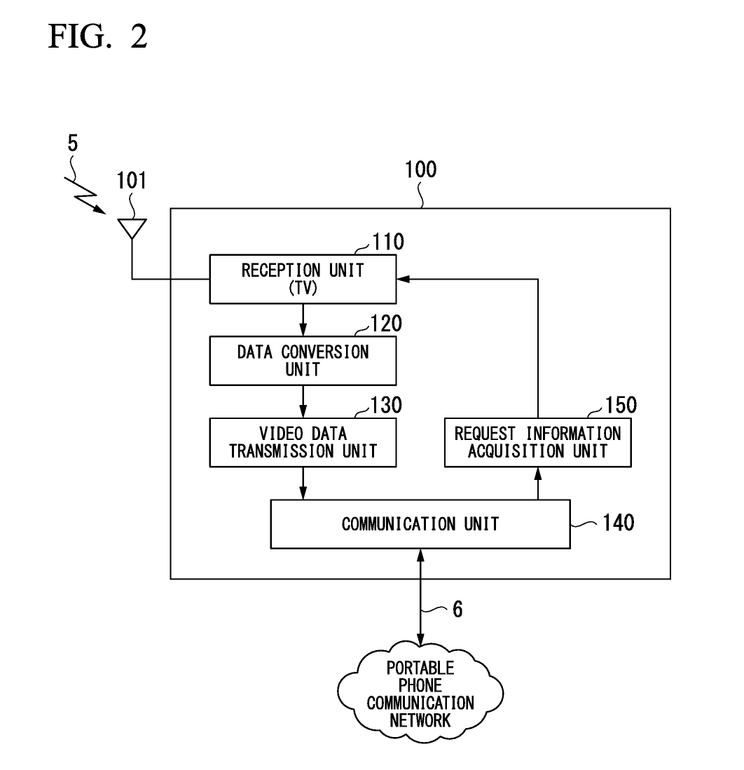

FIG. 2 is a block diagram illustrating an example of a schematic configuration of the virtual set-top box 100 according to the first embodiment.

The virtual set-top box 100 includes a reception unit (TV) 110, a data conversion unit 120, a video data transmission unit 130, a communication unit 140, and a request information acquisition unit 150.

The reception unit (TV) 110 receives broadcast content transmitted from the terrestrial digital broadcast broadcasting company 20, the satellite broadcast broadcasting company 30, or the other broadcasting company 40 based on a program guide. For example, the reception unit (TV) 110 selects a channel of a designated broadcasting station from the broadcast wave 5 received by the antenna 101, performs processing such as demodulation, demultiplexing, etc. on the received wave and receives broadcast content. Here, the designated broadcasting station is, for example, a broadcasting station selected by the user in the portable information terminal 200 or a broadcasting station of a program selected by the user. Then, the reception unit (TV) 110 supplies the received broadcast content to the data conversion unit 120.

The data conversion unit 120 converts the broadcast content received by the reception unit (TV) 110 into video data to be transmitted to the portable information terminal 200. Specifically, the data conversion unit 120 performs processing such as compression, packetization, and the like on the broadcast content received by the reception unit (TV) 110, and converts the broadcast content into video data to be transmitted to the portable information terminal 200. Here, the video data includes image (moving-image or still-image) data, audio data, and other data included in the broadcast content.

The video data transmission unit 130 transmits the video data obtained through the conversion by the data conversion unit 120 to the portable information terminal 200 via the communication unit 140. The communication unit 140 bi-directionally communicates with the portable information terminal 200 using wireless communication 6 via a portable phone communication network. The communication unit 140 may be configured to be connected to the portable phone communication network via the Internet.

The request information acquisition unit 150 acquires request information transmitted from the portable information terminal 200 via the communication unit 140. Here, the request information transmitted from the portable information terminal 200 is request information for requesting broadcast content to be transmitted from the portable information terminal 200 to the TV device 300 and, includes, for example, the information indicating the broadcasting station designated by the user in the portable information terminal 200. Then, the request information acquisition unit 150 supplies the reception unit (TV) 110 with the information indicating the broadcasting station designated in the portable information terminal 200 on the basis of the acquired request information.

Thereby, the reception unit (TV) 110 selects a channel of the designated broadcasting station in the portable information terminal 200 to receive the broadcast content. That is, the reception unit (TV) 110 receives broadcast content from the terrestrial digital broadcast broadcasting company 20, the satellite broadcast broadcasting company 30, or the other broadcasting company 40 based on the program guide according to the request information transmitted from the portable information terminal 200.

The reception unit (TV) 110 may be configured to receive a broadcast wave of one broadcasting station in one time period, or may be configured to be able to receive a plurality of broadcast waves in the same time period.

### (Configuration of Portable Information Terminal 200)

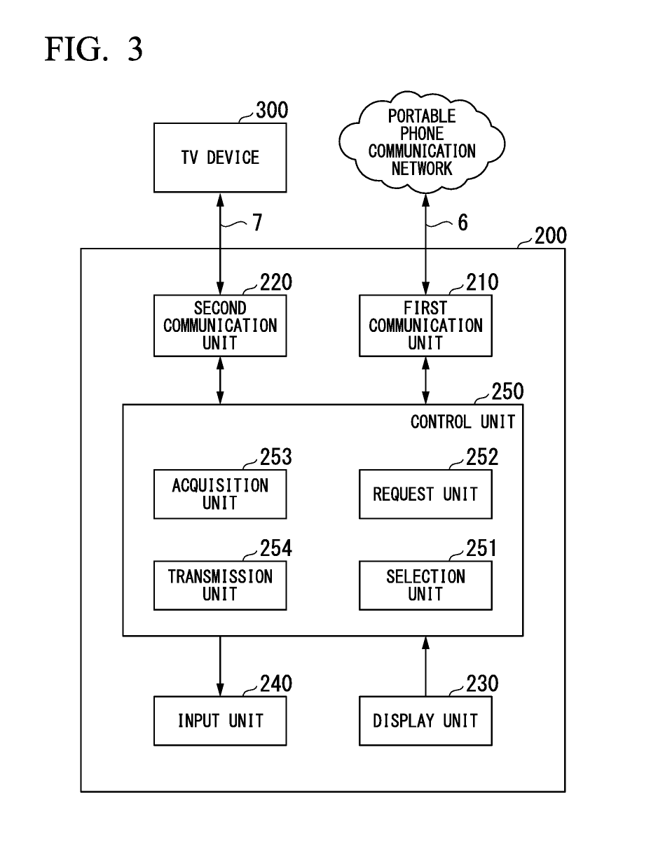

FIG. 3 is a block diagram illustrating an example of a schematic configuration of a portable information terminal 200 according to the first embodiment. The portable information terminal 200 includes a first communication unit 210, a second communication unit 220, a display unit 230, an input unit 240, and a control unit 250.

The first communication unit 210 bi-directionally communicates with the virtual set-top box 100 using the wireless communication 6 via the portable phone communication network. The second communication unit 220 bi-directionally communicates with the TV device 300 in the proximity communication 7.

The display unit 230 and the input unit 240 are superimposed and configured as an integrated touch panel. The display unit 230 includes a liquid crystal display, an organic electro-luminescence (EL) display, or the like, and displays a list of broadcasting stations (a list of channels) capable of being selected by the user, a program guide, or the like.

The input unit 240 detects a touch on the display screen of the display unit 230 and receives an operation input (e.g., a touch operation) from the user. For example, the input unit 240 receives the user's operation input on a list of broadcasting stations, a program guide, or the like displayed on the display unit 230. Also, the input unit 240 outputs input information based on the received operation input to the control unit 250.

The control unit 250 includes a selection unit 251, a request unit 252, an acquisition unit 253, and a transmission unit 254.

The selection unit 251 selects information for specifying the broadcast content to be requested for the virtual set-top box 100 according to the user's operation input. The information for specifying the broadcast content is, for example, information indicating a broadcasting station, program information, or the like.

Specifically, the selection unit 251 causes the display unit 230 to display a selection screen for the user to select the broadcast content capable of being received by the virtual set-top box 100. For example, the selection unit 251 causes the display unit 230 to display a list of broadcasting stations of receivable broadcast content or a program guide as the selection screen. When the user performs an operation input that designates a broadcasting station or a program which the user wants to view on the TV device 300 on this selection screen, the control unit 250 acquires input information based on the operation input from the input unit 240. On the basis of the input information acquired by the control unit 250, the selection unit 251 selects the broadcasting station designated by the user and supplies the request unit 252 with information indicating the selected broadcasting station.

The request unit 252 transmits the request information including the information indicating the broadcasting station supplied from the selection unit 251 as the request information for requesting the broadcast content to be transmitted to the TV device 300 to the virtual set-top box 100 via the first communication unit 210.

The request information is not limited to information indicating the broadcasting station serving as a broadcast content provider, and may include information indicating a broadcasting scheme or program information. The program information is information indicating the broadcasting station and broadcasting times (broadcasting start time, broadcasting end time, etc.), broadcast content, or the like. The broadcasting scheme is, for example, a broadcasting scheme such as terrestrial digital broadcasting, broadcasting satellite (BS) broadcasting, communications satellite (CS) broadcasting, or the like.

Also, the request information may include information for requesting the start of reception or ending of reception (start of viewing or ending of viewing) of the broadcast content. For example, on the selection screen displayed by the selection unit 251 on the display unit 230, a viewing start button or a viewing end button is displayed. When the user inputs an operation on the viewing start button or the viewing end button, the request unit 252 may transmit a request signal for requesting the start of reception or the ending of reception of the broadcast content to the virtual set-top box 100.

The acquisition unit 253 acquires the video data transmitted from the virtual set-top box 100 via the first communication unit 210, using the wireless communication 6 via the portable phone communication network. The video data to be transmitted from the virtual set-top box 100 is, for example, video data based on broadcast content received by the virtual set-top box 100 according to the request information transmitted by the request unit 252 (i.e., broadcast content of the broadcasting station or program designated by the user).

The transmission unit 254 transmits the video data acquired by the acquisition unit 253 to the TV device 300 in the proximity communication 7. Also, when the specification of the acquired video data is different from the reception specification of the TV device 300, the transmission unit 254 may convert the acquired video data into data corresponding to the specification of the TV device 300 and then transmit the data to the TV device 300. The TV device 300 is provided with a communication function of the proximity communication 7 and the user can view the video data transmitted from the portable information terminal 200 on the TV device 300.

### (Operation of Video Display Process)

Next, the operation of the video display process in the video display system 1 will be described.

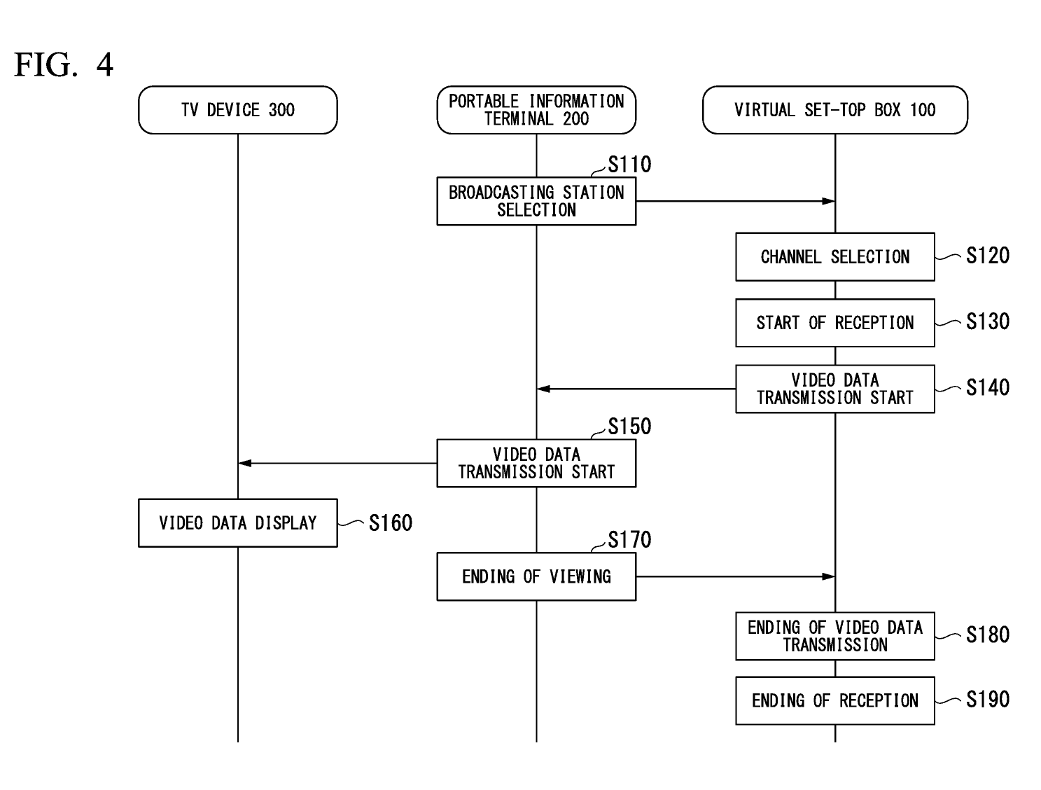

FIG. 4 is an operation diagram illustrating an example of the operation of the video display process according to the first embodiment.

The selection unit 251 of the portable information terminal 200 causes the display unit 230 to display a selection screen including a list of broadcasting stations and a program guide. When an operation input for designating broadcast content (a broadcasting station, a program, or the like) desired to be viewed by the user is made on the displayed selection screen, the selection unit 251 selects a broadcasting station designated by the user on the basis of input information acquired from the input unit 240 and supplies the request unit 252 with information indicating the selected broadcasting station. The request unit 252 transmits request information including the information indicating the broadcasting station supplied from the selection unit 251 as request information for requesting the broadcast content to the virtual set-top box 100 using the wireless communication 6 via the portable phone communication network (step S110).

Next, when the request information is acquired from the portable information terminal 200, the request information acquisition unit 150 of the virtual set-top box 100 supplies information indicating the broadcasting station designated by the portable information terminal 200 to the reception unit (TV) 110. The reception unit (TV) 110 selects a channel of the designated broadcasting station in the portable information terminal 200 (step S120).

Then, the reception unit (TV) 110 starts receiving the broadcast content of the broadcasting station whose channel is selected (step S130). Also, the video data transmission unit 130 starts transmitting the video data into which the data conversion unit 120 converts the broadcast content received by the reception unit (TV) 110 to the portable information terminal 200 using the wireless communication 6 via the portable phone communication network (step S140).

The acquisition unit 253 of the portable information terminal 200 acquires the video data transmitted from the virtual set-top box 100 using the wireless communication 6 via the portable phone communication network. Then, the transmission unit 254 transmits the video data acquired by the acquisition unit 253 to the TV device 300 in the proximity communication 7 (step S150).

The TV device 300 receives and displays the video data transmitted from the portable information terminal 200 in the proximity communication 7 (step S160). Thereby, the user can view the designated broadcast content on the TV device 300.

Next, when the user inputs an operation on the viewing end button in the selection screen displayed on the portable information terminal 200, the selection unit 251 supplies the request unit 252 with information indicating the ending of viewing on the basis of the input information acquired from the input unit 240. When the information indicating the ending of viewing is received from the selection unit 251, the request unit 252 transmits a request signal for requesting ending of reception of the broadcast content to the virtual set-top box 100 using the wireless communication 6 via the portable phone communication network (step S170).

When the request information is acquired from the portable information terminal 200, the request information acquisition unit 150 of the virtual set-top box 100 supplies information indicating ending of reception to the video data transmission unit 130 and the reception unit (TV) 110 on the basis of the request information. Thereby, the video data transmission unit 130 ends the transmission of the video data (step S180). Also, the reception unit (TV) 110 ends the reception of the broadcast content (step S190).

When the user performs an operation of making a change to broadcast content of another broadcasting station during a period from the transmission of the request information for requesting the reception of the broadcast content in step S110 to the ending of viewing in step S170, the portable information terminal 200 returns to the processing of step S110 and transmits request information for requesting the reception of the changed broadcast content to the virtual set-top box 100.

### (Summary of First Embodiment)

As described above, in the video display system 1 according to the present embodiment, the virtual set-top box 100 is provided on the cloud, so that the user can view the broadcast content of terrestrial digital broadcasting, satellite broadcasting, or other broadcasting based on a program guide received by the virtual set-top box 100 if the portable information terminal 200 (e.g., a smartphone) and the TV device 300 are provided. In other words, it is unnecessary to install a set-top box for each TV device. Consequently, according to the present embodiment, it is possible to improve the convenience in viewing the TV.

For example, the virtual set-top box 100 includes a data conversion unit 120 and a video data transmission unit 130. The data conversion unit 120 converts the broadcast content received by the reception unit (TV) 110 into video data to be transmitted to the portable information terminal 200. The video data transmission unit 130 transmits the video data obtained through the conversion by the data conversion unit 120 to the portable information terminal 200 using the wireless communication 6 via the portable phone communication network. The reception unit (TV) 110 may be provided inside the virtual set-top box 100 or may be provided outside the virtual set-top box 100 on the cloud.

Also, the portable information terminal 200 includes an acquisition unit 253 and a transmission unit 254 (an example of a terminal transmission unit). The acquisition unit 253 acquires video data transmitted from the virtual set-top box 100 (i.e., video data into which the virtual set-top box 100 converts the broadcast content received by the reception unit (TV) 110) using the wireless communication 6 via the portable phone communication. The transmission unit 254 transmits the video data acquired by the acquisition unit 253 to the TV device 300 in the proximity communication 7.

As described above, because the virtual set-top box 100, the portable information terminal 200, and the TV device 300 provided on the cloud are connected via wireless communication, it is unnecessary to install a set-top box for each TV, indoor wiring is unnecessary, and complication is eliminated.

Also, because the function of the set-top box is provided as a cloud service 10 by incorporating the virtual set-top box 100 on the cloud, it is possible to collectively perform update operations necessary for each set-top box when the set-top box is installed for each TV device 300. Consequently, it is easy for the latest functions always to be applied in the functions of the virtual set-top box 100 and maintenance of the device becomes easy.

Also, the portable information terminal 200 includes a request unit 252 that transmits request information for requesting broadcast content to be transmitted to the TV device 300 to the virtual set-top box 100 via the portable phone communication network using the wireless communication 6. Then, the reception unit (TV) 110 of the virtual set-top box 100 receives TV broadcast content according to the request information transmitted from the portable information terminal 200 using the wireless communication 6 via the portable telephone communication network.

Thereby, broadcast content desired to be viewed by the user can be viewed by the TV device 300 by requesting the virtual set-top box 100 to provide the broadcast content from the portable information terminal 200.

For example, the portable information terminal 200 includes a selection unit 251 that selects information (e.g., information indicating a broadcasting station, program information, or the like) for specifying the video content requested from the request unit 252 according to the operation input by the user. Specifically, the selection unit 251 causes the display unit 230 to display a list of broadcasting stations of receivable broadcast content and a program guide and receives an operation input for designating a broadcasting station or a program that the user wants to view on the TV device 300, thereby selecting the broadcasting station or the program designated by the user.

Thereby, the user can select a broadcasting station or a program from the list of broadcasting stations displayed on the portable information terminal 200, the program guide, or the like and can view on the TV device 300, so that the convenience at the time of viewing the TV is high.

### Second Embodiment

Next, the second embodiment of the present invention will be described.

In the video display system 1 according to the first embodiment, an example in which the video content received by the virtual set-top box 100 is broadcast content from the terrestrial digital broadcast broadcasting company 20, the satellite broadcast broadcasting company 30, or the other broadcasting company 40 based on the program guide has been described. In the present embodiment, an example in which the video content is broadcast content of cable TV (CATV) will be described.

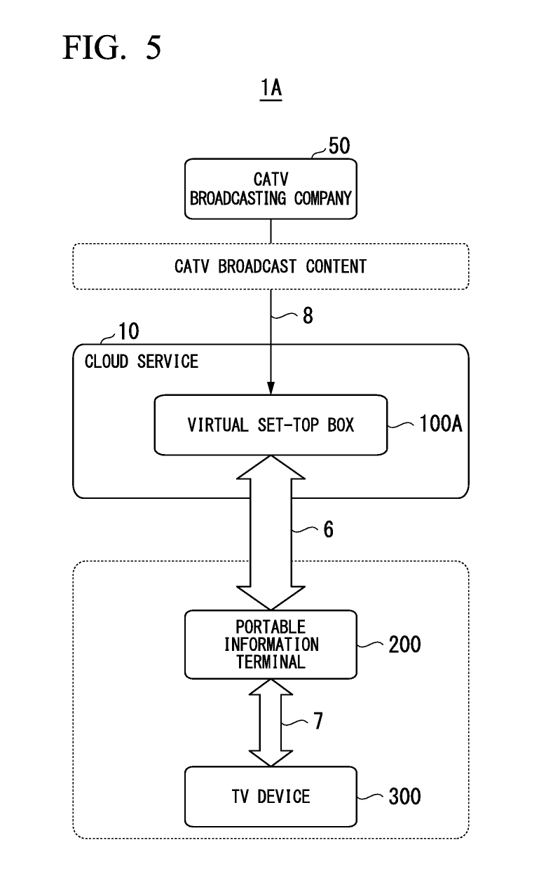

FIG. 5 is a schematic diagram illustrating an example of a video display system 1A according to the second embodiment.

As illustrated in FIG. 5, in the present embodiment, a virtual set-top box 100A receives CATV broadcast content provided by the dedicated cable 8 from each broadcasting company 50 of the CATV as the video content. Other components are similar to those of the video display system 1 according to the first embodiment illustrated in FIG. 1 and description thereof will be omitted.

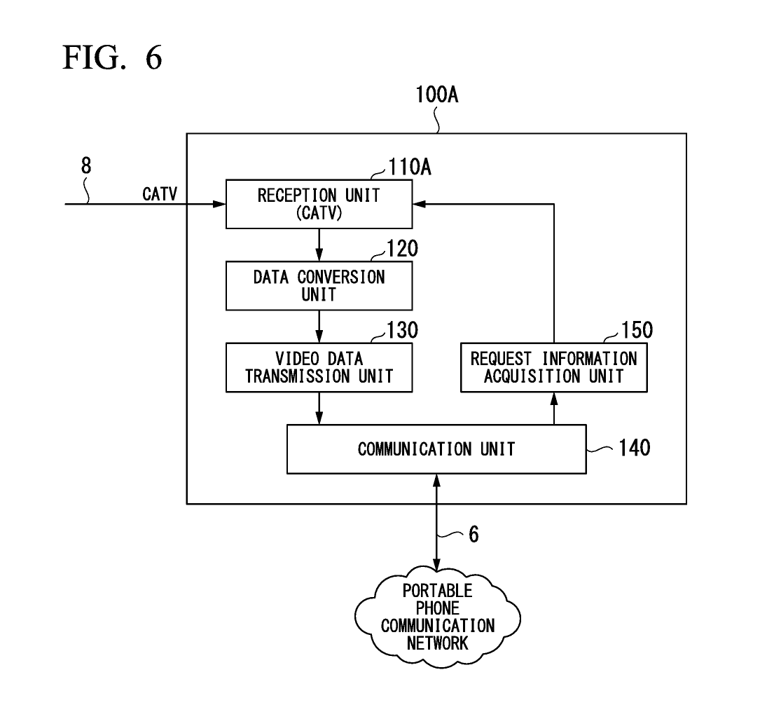

FIG. 6 is a block diagram illustrating an example of a schematic configuration of the virtual set-top box 100A according to the second embodiment. The virtual set-top box 100A includes a reception unit (CATV) 110A, a data conversion unit 120, a video data transmission unit 130, a communication unit 140, and a request information acquisition unit 150. In FIG. 6, the components corresponding to the units of FIG. 2 are denoted by the same reference numerals and the description thereof will be omitted.

The reception unit (CATV) 110A selects a channel of a designated broadcasting station (CATV station) to receive broadcast content of the selected channel among pieces of CATV broadcast content provided by the dedicated cable 8. Then, the reception unit (CATV) 110A supplies the received CATV broadcast content to the data conversion unit 120.

As described above, in the video display system 1A according to the present embodiment, by providing the virtual set-top box 100A on the cloud, the user can view CATV broadcast content if the portable information terminal 200 (e.g., a smartphone) and the TV device 300 are provided. In other words, it is unnecessary to install a set-top box for each TV device 300. Consequently, according to the present embodiment, it is possible to improve the convenience in viewing the CATV.

Also, although a CATV company is normally established for each region, because the virtual set-top box 100A is provided on the cloud, it is possible to view broadcast content having regional specifics in a region different from the region.

### Third Embodiment

Next, the third embodiment of the present invention will be described. In the present embodiment, an example in which video content is video content distributed on video on demand (VOD) will be described.

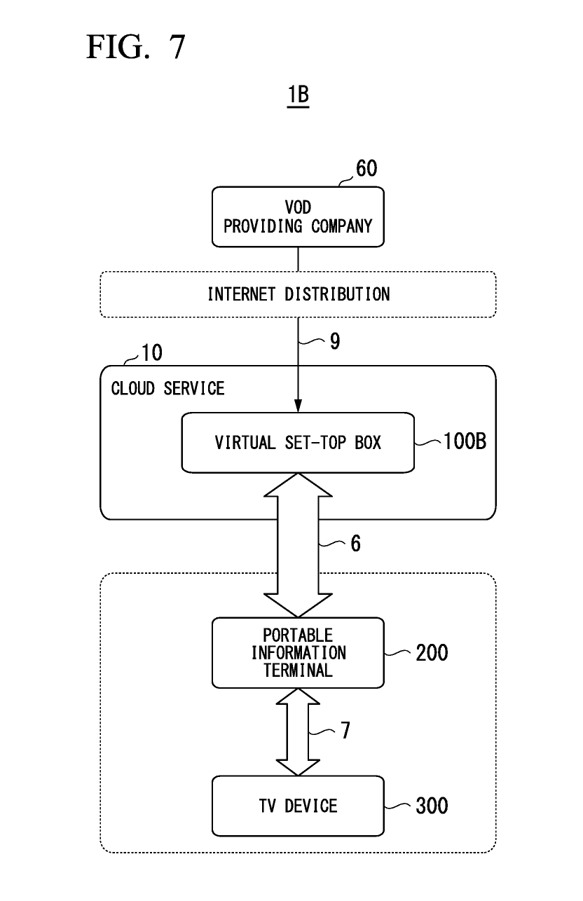

FIG. 7 is a schematic diagram illustrating an example of a video display system 1B according to the third embodiment.

As illustrated in FIG. 7, in the present embodiment, a virtual set-top box 100B receives video content distributed on VOD as video content from a VOD providing company 60 using the Internet 9. Other components are similar to those of the video display system 1 according to the first embodiment illustrated in FIG. 1 and description thereof will be omitted.

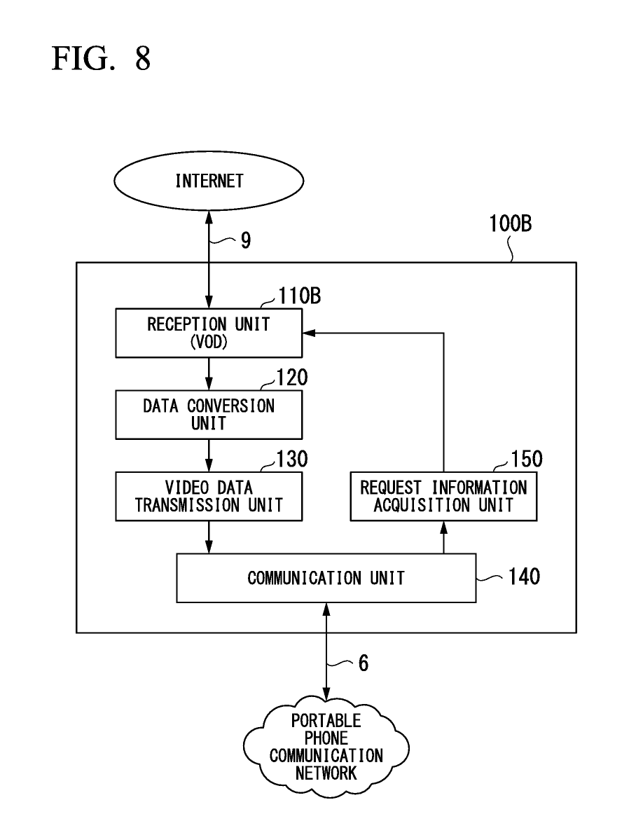

FIG. 8 is a block diagram illustrating an example of a schematic configuration of a virtual set-top box 100B according to the third embodiment. The virtual set-top box 100B includes a reception unit (VOD) 110B, a data conversion unit 120, a video data transmission unit 130, a communication unit 140, and a request information acquisition unit 150. In FIG. 8, the components corresponding to the units of FIG. 2 are denoted by the same reference numerals and the description thereof will be omitted.

The reception unit (VOD) 110B receives designated video content among pieces of video content distributed from a VOD providing company via the Internet 9. In this case, the designated video content is, for example, video content designated by the user from a video content list of the VOD providing company displayed on the display unit 230 of the portable information terminal 200. Then, the reception unit (VOD) 110B supplies the received video content to the data conversion unit 120.

For example, the selection unit 251 of the portable information terminal 200 selects the video content designated by the user and supplies information indicating the selected video content to the request unit 252. The request unit 252 transmits request information for requesting the reception of the video content to the virtual set-top box 100B via the first communication unit 210 on the basis of the information indicating the video content supplied from the selection unit 251. The reception unit (VOD) 110B of the virtual set-top box 100B receives the designated video content from the VOD providing company on the basis of the request information transmitted from the portable information terminal 200.

As described above, in the video display system 1B according to the present embodiment, the virtual set-top box 100B is provided on the cloud, so that the user can view video content distributed on VOD if the portable information terminal 200 (e.g., a smartphone) and the TV device 300 are provided. In other words, it is unnecessary to install a set-top box for each TV device 300. Consequently, according to the present embodiment, it is possible to improve the convenience in viewing the video content based on Internet distribution.

### Fourth Embodiment

Next, the fourth embodiment of the present invention will be described.

In each of the video display systems 1, 1A, and 1B according to the first to third embodiments, a system for enabling TV broadcast content, CATV broadcast content, or video content distributed on VOD to be viewed has been described. In the present embodiment, an example in which any of the TV broadcast content, the CATV broadcast content, and the video content distributed on VOD can be viewed will be described.

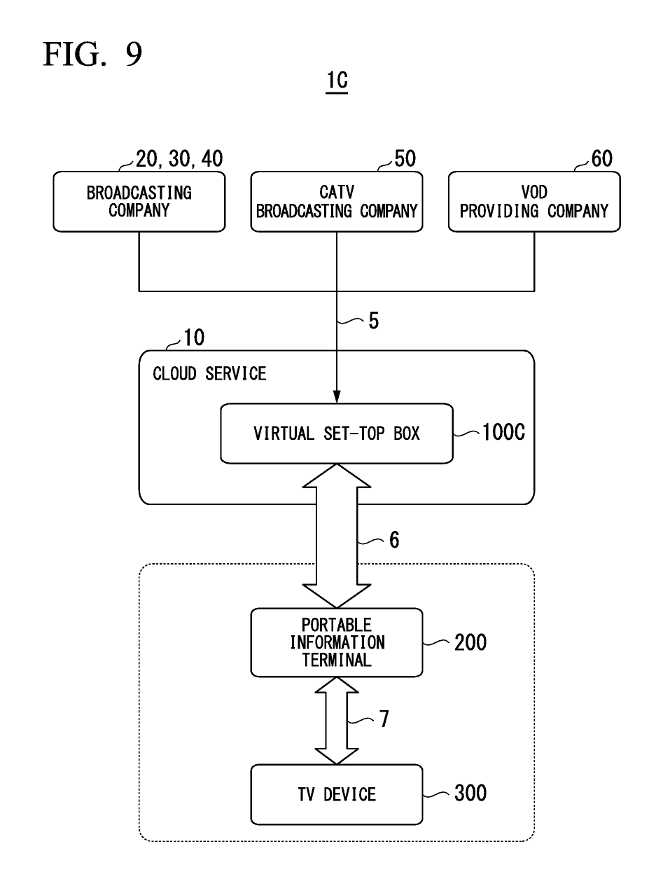

FIG. 9 is a schematic diagram illustrating an example of a video display system 1C according to the fourth embodiment.

As illustrated in FIG. 9, in the present embodiment, a virtual set-top box 100C receives broadcast content provided by broadcast waves 5 from TV broadcasting companies 20, 30, and 40, CATV broadcast content provided by the dedicated cable 8 from a CATV broadcasting company 50, and video content distributed by the Internet 9 from a VOD providing company 60, as video content. Other components are similar to those of the video display systems 1, 1A, and 1B according to the first to third embodiments illustrated in FIGS. 1, 5, and 7, and description thereof will be omitted.

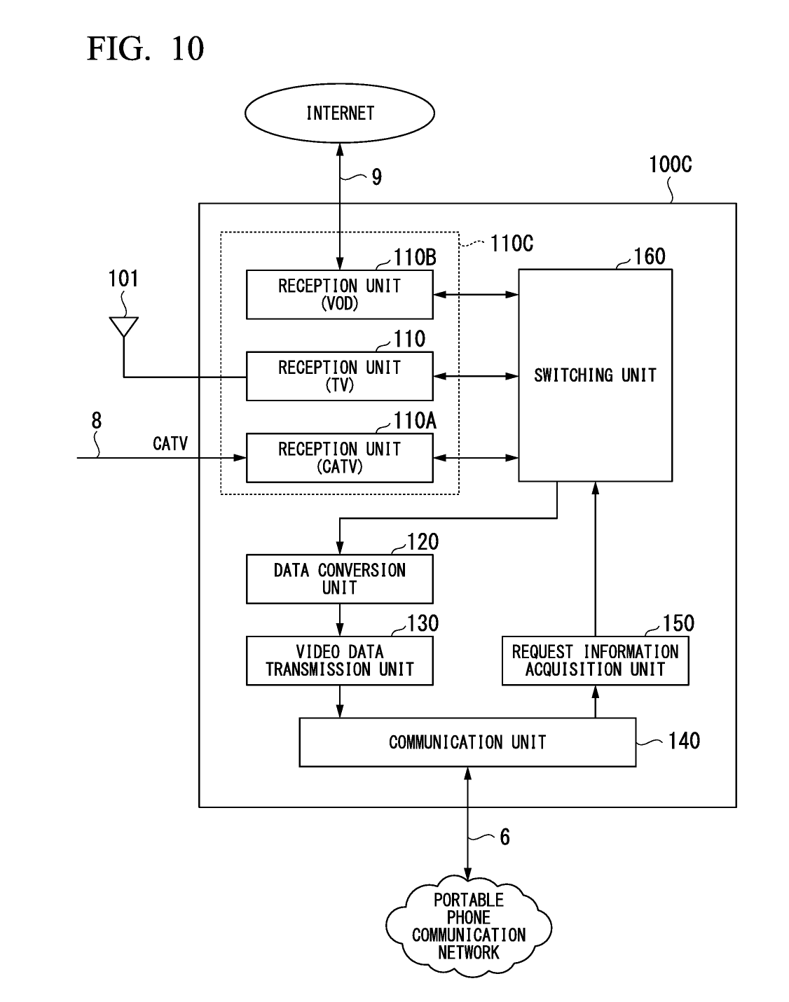

FIG. 10 is a block diagram illustrating an example of a schematic configuration of a virtual set-top box 100C according to the fourth embodiment. The virtual set-top box 100C includes a reception unit 110C, a data conversion unit 120, a video data transmission unit 130, a communication unit 140, a request information acquisition unit 150, and a switching unit 160C. In FIG. 10, the components corresponding to the units of FIGS. 2, 6, and 8 are denoted by the same reference numerals and the description thereof will be omitted.

The reception unit 110C includes three reception units which are a reception unit (TV) 110, a reception unit (CATV) 110A, and a reception unit (VOD) 110B. The switching unit 160C switches the reception unit to be operated among the above-described three reception units according to a request for content from broadcast content provided by a broadcast wave 5, CATV broadcast content provided by a dedicated cable 8, and video content distributed by the Internet 9 for the request information acquired by the request information acquisition unit 150 from the portable information terminal 200.

Also, the request information acquired from the portable information terminal 200 includes information indicating one designated broadcasting scheme among terrestrial digital broadcasting, satellite broadcasting, CS broadcasting, CATV broadcasting, VOD, and the like as broadcast content.

As described above, the reception unit 110C of the virtual set-top box 100C can receive video content transmitted in a plurality of broadcasting schemes and receives video content according to request information transmitted from a portable information terminal 200 among pieces of video content transmitted in the plurality of broadcasting schemes. Thereby, in the video display system 1C according to the present embodiment, a set-top box is not required for each of services in various broadcasting schemes and the user can view video content transmitted in the plurality of broadcasting schemes if the portable information terminal 200 (e.g., a smartphone) and a TV device 300 are provided. Consequently, according to the present embodiment, it is possible to improve the convenience when viewing video content based on various broadcasting schemes.

Also, because the functions of set-top boxes corresponding to the plurality of broadcasting systems are provided as the cloud service 10, it is possible to collectively make contracts of the set-top boxes, thereby improving the convenience for the user.

### Fifth Embodiment

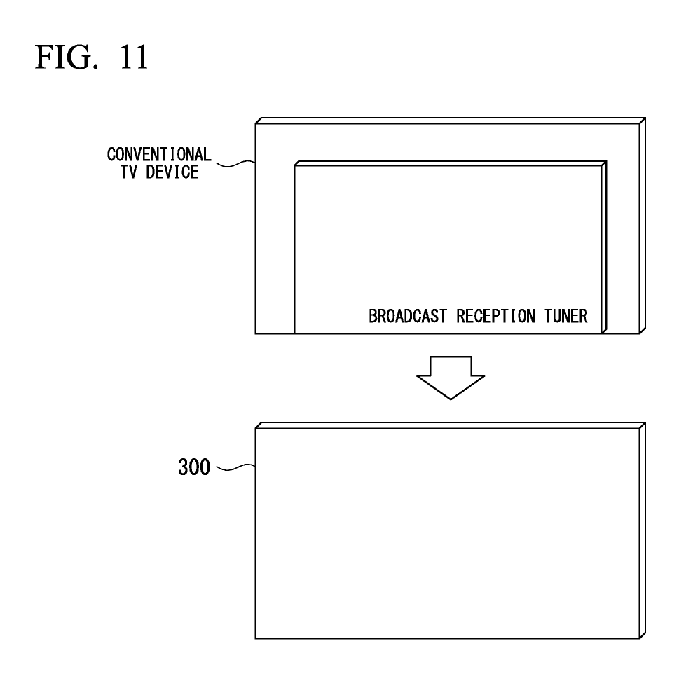

Next, the fifth embodiment of the present invention will be described. As described in the above-described first to fourth embodiments, because the function of the set-top box is provided as the cloud service 10 by incorporating the virtual set-top box 100 (100A, 100B, or 100C) on the cloud, a reception function of receiving the broadcast content is unnecessary in the TV device 300. Thus, in the TV device 300 according to the present embodiment, for example, as illustrated in FIG. 11, because it is possible to omit the installation of a tuner for broadcast reception necessary for a conventional TV device, it is possible to achieve thickness reduction, weight reduction, and cost reduction.

Even when the TV device 300 is equipped with a tuner for broadcast reception as in a conventional TV device, it can be applied without having to use its function.

### MODIFIED EXAMPLE

Although the first to fifth embodiments of the present invention have been described above in detail with reference to the drawings, specific configurations are not limited to the embodiments, and designs or the like without departing from the spirit and scope of the present invention are also included. For example, the functions and configurations described in the first to fifth embodiments described above can be arbitrarily combined.

Although the example in which the video data is wirelessly transmitted from a portable information terminal 200 to a TV device 300 using proximity communication 7 has been described in the above-described embodiment, the video data may be transmitted from the portable information terminal 200 to the TV device 300 in a wired manner. For example, by connecting the portable information terminal 200 and the TV device 300 with an HDMI (registered trademark) cable, a cable of a wired LAN, a universal serial bus (USB) cable, or the like, video data may be transmitted from the portable information terminal 200 to the TV device 300 in a wired manner.

When the TV device 300 does not have a wireless communication function, an adapter capable of adding a wireless communication function may be connected to the TV device 300, and video data may be wirelessly transmitted from the portable information terminal 200 to the TV device 300.

Although FIGS. 1, 5, 7, and 9 illustrate examples of system configurations of the virtual set-top boxes 100 (100A, 100B, and 100C) and one set of the portable information terminal 200 and the TV device 300 in the above-described embodiment, a system configuration of the virtual set-top boxes 100 (100A, 100B, and 100C) and a plurality of portable information terminals 200 and TV devices 300 can be made. That is, the virtual set-top boxes 100 (100A, 100B, and 100C) transmit the video content of the TV device 300 via the plurality of portable information terminals 200. Thereby, video content received by the virtual set-top boxes 100 (100A, 100B, and 100C) can be viewed on the TV devices 300 installed in each home via the portable information terminals 200 of each user living at each home. When a plurality of TV devices 300 are installed in the home, video content can be viewed by any of a plurality of TV devices 300 in the home via the portable information terminal 200 of the user living at the home. Also, the portable information terminal 200 may receive video content from the virtual set-top box 100 (100A, 100B, or 100C) at any place as long as a communication environment connectable to the public network and the wireless communication 6 is fulfilled and the received video content can be viewed on the TV device 300. In other words, as long as a communication environment based on the wireless communication 6 is fulfilled, it is possible to view broadcast content of terrestrial digital broadcasting or satellite broadcasting, CATV broadcast content, video content distributed on VOD, etc. outside as well as inside the home or the like by providing the portable information terminals 200 and the TV device 300.

Also, the components of the virtual set-top boxes 100 (100A, 100B, and 100C) can be arranged dispersedly or collectively on arbitrary devices on the cloud.

Also, some functions of the virtual set-top box 100 (100A, 100B, or 100C) or the portable information terminal 200 in the above-described embodiment may be configured to be implemented by a computer. In this case, the above-described functions may be implemented by recording a program for implementing the above-described functions on a computer-readable recording medium and causing a computer system to read and execute the program recorded on the recording medium. Also, the “computer system” used here is a computer system embedded in a terminal device and is assumed to include an operating system (OS) and hardware such as peripheral devices. In addition, the computer-readable recording medium refers to a storage device, including a flexible disk, a magneto-optical disc, a read only memory

(ROM), a portable medium such as a compact disc (CD)-ROM, and a hard disk embedded in the computer system. Further, the “computer-readable recording medium” is assumed to include a computer-readable recording medium for dynamically holding a program for a short time as in a communication line when the program is transmitted via a network such as the Internet or a communication circuit such as a telephone circuit and a computer-readable recording medium for holding the program for a predetermined time as in a volatile memory inside the computer system including a server and a client when the program is transmitted. In addition, the above-described program may be used to implement some of the above-described functions. Further, the program may implement the above-described functions in combination with a program already recorded on the computer system.

### DESCRIPTION OF THE REFERENCE SYMBOLS

1, 1A, 1B, 1C Video display system
5 Broadcast wave
6 Wireless communication
7 Proximity communication
8 Dedicated cable
9 Internet
10 Cloud service
20 Terrestrial digital broadcast broadcasting company
30 Satellite broadcast broadcasting company
40 Other broadcasting company based on program guide
50 CATV broadcasting company
60 VOD providing company
100, 100A, 100B, 100C Virtual set-top box
110 Reception unit (TV)
110A Reception unit (CATV)
110B Reception unit (VOD)
110C Reception unit
120 Data conversion unit
130 Video data transmission unit
140 Communication unit
150 Request information acquisition unit
160C Switching unit
200 Portable information terminal
210 First communication unit
220 Second communication unit
230 Display unit
240 Input unit
250 Control unit
251 Selection unit
252 Request unit
253 Acquisition unit
254 Transmission unit
300 TV device

1-12. (canceled)

13. A video display system comprising an information processing device and a portable terminal device,
wherein the information processing device comprises:
a reception unit configured to receive video contents;
a conversion unit configured to convert the video contents received by the reception unit into video data to be transmitted to the portable terminal device; and
a transmission unit configured to transmit the video data obtained through a conversion by the conversion unit to the portable terminal device using a wireless communication via a public network, and
wherein the portable terminal device comprises:
an acquisition unit configured to acquire the video data transmitted from the information processing device using the wireless communication via the public network; and
a terminal transmission unit configured to transmit the video data acquired by the acquisition unit to a display device using the wireless communication.

14. The video display system according to claim 13,
wherein the video contents received by the reception unit includes broadcast contents transmitted by a broadcast wave of a television.

15. The video display system according to claim 13,
wherein the video contents received by the reception unit includes cable television broadcast contents transmitted via a cable.

16. The video display system according to claim 13,
wherein the video contents received by the reception unit includes video contents distributed on a video on demand.

17. The video display system according to claim 13,
wherein the reception unit receives the video contents according to a request information transmitted from the portable terminal device using the wireless communication via the public network, and
wherein the portable terminal device comprises:
a request unit configured to transmit the request information for requesting a video content to be transmitted to the display device to the information processing device using the wireless communication via the public network.

18. The video display system according to claim 17,
wherein the reception unit is able to receive the video contents transmitted in a plurality of broadcasting schemes, and
wherein the reception unit receives a video content according to the request information to be transmitted from the portable terminal device among video contents transmitted in the plurality of broadcasting schemes.

19. The video display system according to claim 17,
wherein the request information transmitted by the request unit includes an information indicating a selected broadcasting scheme, a video content provider, or a program.

20. The video display system according to claim 13,
wherein the information processing device comprises one or more servers connected to the public network and is configured as a server that provides the portable terminal device with the video contents received according to a request information transmitted from the portable terminal device.

21. An information processing device comprising:
a conversion unit configured to convert video contents received by a reception unit into video data to be transmitted to a portable terminal device; and
a transmission unit configured to transmit the video data obtained through a conversion by the conversion unit to the portable terminal device using a wireless communication via a public network.

22. A portable terminal device comprising:
an acquisition unit configured to acquire video data into which an information processing device converts video content received by a reception unit from the information processing device using a wireless communication via a public network; and
a terminal transmission unit configured to transmit the video data acquired by the acquisition unit to a display device using the wireless communication.

23. The portable terminal device according to claim 22, the portable terminal device comprising:
a request unit configured to transmit a request information for requesting a video content for transmission to a display device to the information processing device using the wireless communication via the public network; and
a selection unit configured to select an information for specifying the video content requested from the request unit according to an operation input of a user.
